(19) United States
(12) Patent Application Publication
(10) Pub. No.: US 2009/0262375 A1
(43) Pub. Date: Oct. 22, 2009

(54) LIQUID EJECTING APPARATUS AND LIQUID EJECTING METHOD

(75) Inventors: Tomohiro Yuda, Nagano-ken (JP); Bunji Ishimoto, Nagano-ken (JP); Akito Sato, Nagano-ken (JP); Takeshi Tanoue, Nagano-ken (JP); Naoki Sudo, Nagano-ken (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/427,923

(22) Filed: Apr. 22, 2009

(30) Foreign Application Priority Data
Apr. 22, 2008 (JP) 2008-111650

(51) Int. Cl. G06F 15/00

(52) U.S. Cl. 358/1.9

(57) ABSTRACT

[Task] To improve the quality of an image formed by a liquid ejecting apparatus capable of performing a bi-direction printing process.

[Means for Resolution] A raster (POL raster) formed by a partial overlap (POL) is formed such that pixels (first type of dots) formed upon a going movement and pixels (second type of dots) formed upon a coming movement are alternately arranged. The first type of dots and the second type of dots can be alternately formed by controlling an amount of transport of a print sheet and an amount of feed in a horizontal direction (main scanning direction) of a recording head. In this way, it is possible to alternately form the dots formed in opposing filling directions in the POL raster. By changing the allocation of the POL nozzles in an odd-numbered pass and an even-numbered pass and performing an anomalous feeding process of the print sheet, it is possible to change a combination of the POL nozzles forming the POL raster. Accordingly, since a noise occurring in the main scanning direction of an image printed on the print sheet can be restrained, it is possible to improve the quality of an image.

### BACKGROUND OF THE INVENTION

1. Field of the Invention

The present invention relates to a liquid ejecting apparatus capable of forming an image on a print medium by ejecting a liquid.

2. Invention of Related Art

### [Background Art]

As a liquid ejecting apparatus, there has been used an ink jet type printer (hereinafter, referred to as an ink jet printer) that forms dots by moving a recording head, which has a plurality of nozzles forming the dots and arranged at a predetermined interval in a transport direction of a recording sheet, in a main scanning direction and forms an image by transporting the recording medium in a sub-scanning direction intersecting the main scanning direction.

[Patent Document 1] JP-A-2002-11859

### DISCLOSURE OF THE INVENTION

### Problem that the Invention it to Solve

In the ink jet printer, there is a printing process called a bi-direction printing process in which pixels are formed upon a going movement and a coming movement of a recording head in the main scanning direction. In the ink jet printer performing the bi-direction printing process, directions in which a liquid is printed to form dots are reverse to each other upon the going movement and the coming movement (hereinafter, in the specification, the direction in which the liquid is printed to form the dots is referred to as “a dot-filling direction”). In the past, since the ink jet printer performing the bi-direction printing process formed the dots corresponding to one raster line in a main scanning process of the same direction, the dots constituting each raster line were different from each other in the dot-filling direction. In consequence, image quality deterioration such as a stripe formed in the main scanning direction occurs in a boundary between the raster lines of which the dot-filling directions are different. Therefore, a problem occurs in that the quality of an image formed on the recording medium deteriorates.

In order to prevent the image quality deterioration such as the stripe caused due to a nozzle manufacturing error, a feeding error in a sub-scanning process, or the like, an ink jet printer performing a control method called an overlap recording method has been suggested. The overlap recording method is a control method of controlling dot ejection from nozzles and transport of the recording medium so as to form a plurality of pixels on the same raster line by two or more predetermined nozzles (hereinafter, referred to as overlap nozzles) arranged at different positions in the sub-scanning direction. When the overlap recording method is applied in the bi-direction printing process, the transport of the overlap nozzles and the recording medium is uniform. Therefore, each raster line is formed by the overlap nozzles combined in the same manner. For this reason, when a manufacture error occurs in the combined overlap nozzles, the quality of an image area shown by the raster lines formed by the overlap nozzles in which there is the manufacture error may deteriorate. In consequence, a problem occurs in that the quality of an image formed on the recording medium deteriorates as a whole.

Moreover, in the bi-direction printing process, the quality of an image may deteriorate due to various causes such as a manufacture error of a unit transporting the recording medium or bending of the recording medium as well as the nozzle manufacturing error.

The invention is devised in view of the above-mentioned problems and an object of the invention is to improve the quality of an image formed by a liquid ejecting apparatus performing a bi-direction printing process.

### SUMMARY OF THE INVENTION

### Means for Solving the Problem

The present invention is devised to solve some of the above-mentioned problems and embodied as the aspects or applied examples described below.

### FIRST APPLIED EXAMPLE

A liquid ejecting apparatus that forms an image on a recording medium includes: a recording head that is provided with a nozzle row having a plurality of nozzles; a head driving unit that moves the recording head in a main scanning direction; a transport unit that transports the recording medium in a sub-scanning direction intersecting the main scanning direction; and a dot control unit that ejects a liquid on the recording medium from the nozzles to form raster lines on the recording medium by controlling the head driving unit and the transport unit and that forms dots upon a going movement and dots upon a coming movement of the recording head in the main scanning direction and forms overlap raster lines of which one raster line contains the dots formed upon the going movement and the dots formed upon the coming movement.

According to the liquid ejecting apparatus in the first applied example, the dots formed by printing the liquid in the direction of the going movement and the dots formed by printing the liquid in the direction of the coming direction are contained in one raster line. With such a configuration, since the dots formed in different filling directions are contained in the raster line, a noise occurring in the main scanning direction of an image printed on the recording medium can be restrained. Accordingly, it is possible to improve the quality of an image.

In the liquid ejecting apparatus of the first applied example, the dot control unit may form the overlap raster lines so that pixels formed upon the going movement and pixels formed upon the coming movement are alternately arranged. According to the liquid ejecting apparatus in the first applied example, the dots formed in opposing filling directions are formed so as to be alternated by one dot in the main scanning direction. Accordingly, it is possible to restrain the occurrence of the noise with a high precision.

In the liquid ejecting apparatus of the first applied example, the dot control unit may form the overlap raster lines by use of two nozzles arranged at different locations in the sub-scanning direction among the plurality of nozzles. In addition, the dot control unit may form a first overlap raster line by use of a first nozzle and a second nozzle among the plurality of nozzles and forms a second overlap raster line by use of the first nozzle and a third nozzle different from the second nozzle, by transporting the recording medium by a first amount of transport in the sub-scanning direction upon ending the going movement of the recording head in the main scanning direction and by transporting the recording medium by a second amount of transport different from the first amount of transport upon ending the coming movement of the recording head in the main scanning direction. According to the liquid ejecting apparatus in the first applied example, the amounts of transport of the recording medium are different at the time of ending the main scanning process performed in the going movement and at the time of ending the main scanning process performed in the coming movement. Therefore, the combination of the nozzles forming the dots contained in the overlap raster line is changed. Accordingly, even when a nozzle manufacturing error occurs, it is possible to prevent the quality of an image from deteriorating due to the manufacturing error.

In the liquid ejecting apparatus of the first applied example, the dot control unit may intermittently form the dots from n nozzles (where n is an integer equal to or larger than 1) provided in an upper end of the nozzle row and m nozzles (where m is an integer equal to or larger than 1) provided in a lower end of the nozzle row among the plurality of nozzles of the nozzle row upon the going movement of the recording head in the main scanning direction and intermittently form the dots from m nozzles provided in the upper end and n nozzles provided in the lower end among the plurality of nozzles of the nozzle row upon the coming movement of the recording head in the main scanning direction, so as to form the first overlap raster line by use of the first and second nozzles and form the second overlap line by use of the first and third nozzles. According to the liquid ejecting apparatus in the first applied example, when the partial overlap recording method of recording only some raster lines in an overlap manner is applied, the nozzles provided in the upper end of the nozzle row and the nozzles provided in the lower end thereof are used as the nozzles intermittently forming the dots, and thus the number of nozzles intermittently forming the dots in the main scanning process of the going movement and the coming movement is alternated in the upper end and the lower end. Therefore, the combination of the nozzles forming the dots contained in the overlap raster line is changed. Accordingly, it is possible to prevent the quality of an image from deteriorating due to the manufacturing error.

In the liquid ejecting apparatus of the first applied example, the dot control unit may intermittently form the dots from all the plurality of nozzles of the nozzle row. According to the liquid ejecting apparatus in the first applied example, the dots formed in the different filling directions are contained in each overlap raster line even in the liquid ejecting apparatus in which all the nozzles are the overlap nozzles. Accordingly, it is possible to improve the quality of an image formed on the recording medium.

In the liquid ejecting apparatus of the first applied example, the dot control unit may form the overlap raster lines by the dots ejected with non-continuous movement of the recording head in the main scanning direction. According to the liquid ejecting apparatus in the first applied example, the dots formed in the different filling directions are not formed with the continuous main scanning process in the overlap raster line. Therefore, ones of the dots formed when the filling direction is the direction of the going movement and the dots when the filling direction is the coming movement are formed. After some time passes and the ones are sufficient dried, the other dots are formed. Accordingly, it is possible to prevent the dots from bleeding.

The above-described various aspects of the invention may be appropriately combined or a part thereof may be omitted. The invention is not only embodied as the above-described liquid ejecting apparatus, but also embodied as a dot forming method performed by the liquid ejecting apparatus, a computer program for allowing the liquid ejecting apparatus to perform the formation of the dots, a computer-readable recording medium recording the related computer program, and the like. In any configuration, the above-described aspects can be appropriately applied. As the computer-readable recording medium, various mediums such as a flexible disk, a CD-ROM, a DVD-ROM, a magneto-optical disk, an IC card, and a hard disk can be used.

### BRIEF DESCRIPTION OF THE DRAWINGS

FIG. 1 is a block diagram illustrating the configuration of a printing system according to a first embodiment of the invention.

FIG. 2 is a schematic diagram illustrating a printer 20 according to the first embodiment.

FIG. 3 is a block diagram illustrating the configuration of the printer 20 by focusing a control circuit 40 according to the first embodiment.

FIG. 4 is an explanatory diagram illustrating nozzle arrangement on the lower surface of a recording head 28 according to the first embodiment.

FIG. 5 is an explanatory diagram illustrating a printing process when an overlap recording method is applied to a bi-direction printing process.

FIG. 6 is a table showing allocation of POL nozzles in each main scanning process according to the first embodiment.

FIG. 7 is a schematic diagram illustrating the POL nozzles according to the first embodiment.

FIG. 8 is an explanatory diagram illustrating a printing method according to the first embodiment.

FIG. 9 is an explanatory diagram illustrating the printing method according to the first embodiment.

FIG. 10 is an explanatory diagram illustrating a printing method according to a second embodiment.

FIG. 11 is an explanatory diagram illustrating a printing method according to a third embodiment.

FIG. 12 is an explanatory diagram illustrating a printing method according to a fourth embodiment.

FIG. 13 is an explanatory diagram illustrating a printing method according to a fifth embodiment.

FIG. 14 is an explanatory diagram illustrating a printing method according to a sixth embodiment.

FIG. 15 is an explanatory diagram illustrating a printing method according to a seventh embodiment.

### DESCRIPTION OF REFERENCE NUMERALS AND SIGNS

20: COLOR PRINTER

22: MOTOR

24: CARRIAGE MOTOR

26: PLATEN

28: RECORDING HEAD

28: PRINTING HEAD

30: CARRIAGE

32: OPERATION PANEL

34: SLIDING AXIS

36: DRIVING BELT

38: PULLEY

39: LOCATION SENSOR

40: CONTROL CIRCUIT

41: CPU

52: HEAD DRIVING CIRCUIT

54: MOTOR DRIVING CIRCUIT

56: CONNECTOR

60: RECORDING HEAD UNIT

90: COMPUTER

91: VIDEO DRIVER

95: APPLICATION PROGRAM

96: PRINTER DRIVER

97: RESOLUTION CONVERTING MODULE

98: COLOR CONVERTING MODULE

99: HALFTONE MODULE

100: RASTERIZATION

300: IMAGE

### DESCRIPTION OF PREFERRED EMBODIMENT

### Best Mode for Carrying Out the Invention

### A. First Embodiment

### A1. Printing System Configuration

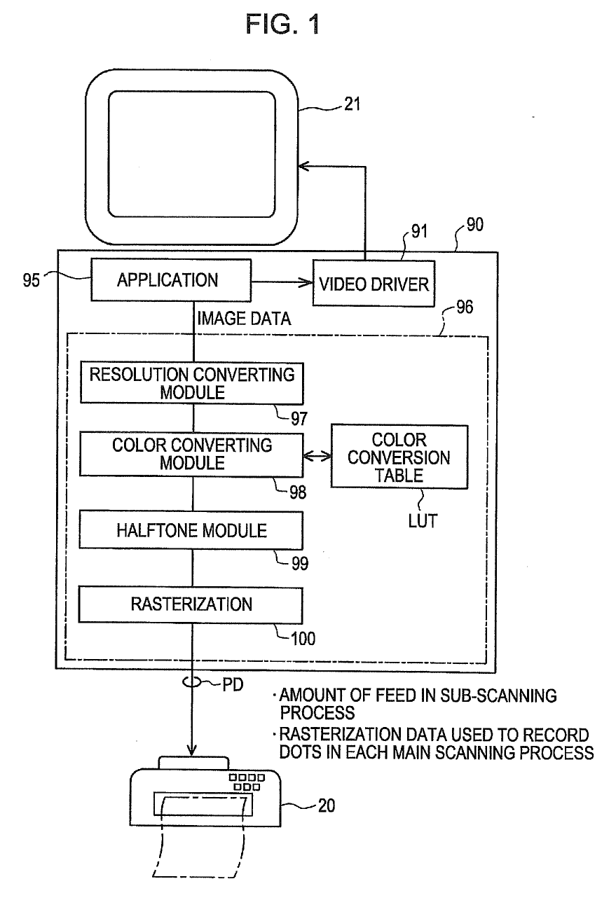

FIG. 1 is a block diagram illustrating the configuration of a printing system according to a first embodiment of the invention. The printing system includes a computer 90 and a color printer 20. The printer 20 and computer 90 can be called a “liquid ejecting apparatus” in a broad sense. Alternatively, the printer 20 and a program that is installed in the computer 90 and realizes a function of a printer driver can be called the liquid ejecting apparatus in a broad sense. Alternatively, a printer that has the function of the printer driver can be called the liquid ejecting apparatus.

In the computer 90, an application program 95 operates under a predetermined operating system. In the operating system, a video driver 91 or a printer driver 96 is embedded. Print data PD to be transported to the printer 20 are output from the application program 95 through these drivers. The application program 95 executing re-touch of an image or the like executes a desired process on an image to be processed and also displays an image on a CRT 21 through the video driver 91.

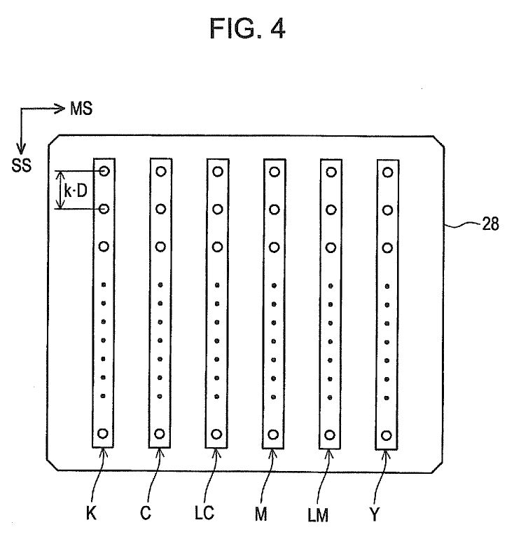

When the application program 95 starts a printing command, the printer driver 96 of the computer 90 acquires image data from the application program 95 and converts the acquired image data into the print data PD to be supplied to the printer 20. In an example shown in FIG. 4, the printer driver 96 includes a resolution converting module 97, a color converting module 98, a halftone module 99, a rasterization 100, and a color conversion lookup table LUT therein.

The resolution converting module 97 serves as converting the resolution (that is, the number of pixels per unit length) of color image data generated by the application program 95 into a print resolution. The image data of which the resolution is converted in this manner are image information constituted by three RGB color components. Referring to the color conversion lookup table LUT, the color converting module 98 converts the RGB image data for each pixel into multiple gray-scales data of plural ink colors usable in the printer 20.

The color-converted multiple gray-scales data have gray scale values of 256 gray scales, for example. The halftone module 99 generates halftone image data by executing a so-called halftone process. The halftone image data are output as final print data PD that are sorted by the rasterization 100 in a sequence in which data are transmitted to the printer 20. In addition, the print data PD include raster data representing a dot record state at the time of each main scanning process and data representing an amount of transport.

The printer driver 96 corresponds to a program executing a function of generating the print data PD. That is, the printer driver 96 corresponds to “a dot control unit” of claims. A program executing a function of the printer driver 96 is supplied in a form recorded in a computer-readable recording medium. As this recording medium, there can be used various computer-readable mediums such as a flexible disk, a CD-ROM, a magneto-optical disk, an IC card, a ROM cartridge, a punch card, a print recorded with signs such as a barcode, and an internal storage unit (a memory such as a RAM or a ROM) and external storage unit of a computer.

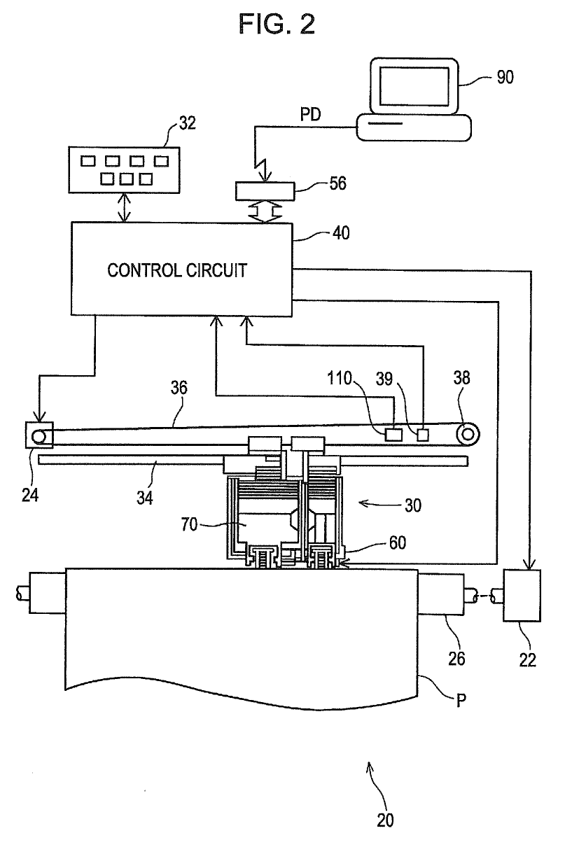

FIG. 2 is a schematic diagram illustrating the configuration of the printer 20 according to the first embodiment. The printer 20 includes a sub-scanning transport mechanism that allows a sheet feeding motor 22 to transport a print sheet P in a sub-scanning direction, a main scanning transport mechanism that allows a carriage motor 24 to reciprocate a carriage 30 in an axial direction (a main scanning direction) of a platen 26, a head driving mechanism that drives a recording head unit 60 mounted on the carriage 30 to control ink ejection and dot formation, and a control circuit 40 that controls transmission and reception of signals among the sheet transporting motor 22, the carriage motor 24, the recording head unit 60, and the operation panel 32. The control circuit 40 is connected to the computer 90 through a connector 56.

The sub-scanning feeding mechanism that feeds the print sheet P includes a gear train (not shown) that transfers the rotation of the sheet feeding motor 22 to the platen 26 and a print sheet transport roller (not shown). The main scanning feeding mechanism that reciprocates the carriage 30 includes a sliding axis 34 that maintains the carriage 30 disposed in parallel to the axis of the platen 26 so as to be slidable, a pulley 38 in which an endless driving belt 36 is suspended in the carriage motor 24, and a location sensor 39 that detects an origin location of the carriage 30.

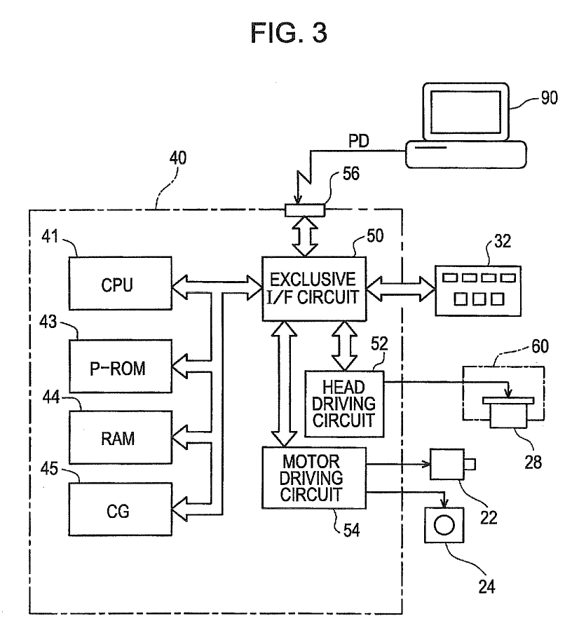

FIG. 3 is a block diagram illustrating the configuration of the printer 20 by focusing a control circuit 40 according to the first embodiment. The control circuit 40 is configured as an arithmetic logic unit that includes a CPU 41, a programmable ROM (PROM) 43, a RAM 44, and a character generator (CG) 45 storing a dot matrix of characters. The control circuit 40 further includes an exclusive I/F circuit 50 that exclusively interfaces an external motor or the like, a head driving circuit 52 that is connected to the exclusive I/F circuit 50 and drives the recording head unit 60 to eject ink, and a motor driving circuit 54 that drives the sheet feeding motor 22 and the carriage motor 24. Since the exclusive I/F circuit 50 has a parallel interface circuit therein, the exclusive I/F circuit can receive the print data PD to be supplied from the computer 90 through the connector 56. The printer 20 performs a printing process in accordance with the print data PD. The RAM 44 functions as a buffer memory that temporarily stores raster data.

The recording head unit 60 includes a recording head 28 and can be mounted with an ink cartridge. In addition, the recording head unit 60 as one constituent element is detachably mounted on the printer 20. That is, when the recording head 28 is exchanged, the recording head unit 60 is exchanged.

FIG. 4 is an explanatory diagram illustrating nozzle arrangement on the lower surface of the recording head 28 according to the first embodiment. On the lower surface of the recording head 28, a nozzle row K for ejecting black ink, a nozzle row C for ejecting cyan ink, a nozzle row Lc for ejecting light cyan ink, a nozzle row M for ejecting magenta ink, a nozzle row Lm for ejecting light magenta ink, and a nozzle row Y for ejecting yellow ink are formed from the right side of the drawing.

A plurality of nozzles in each nozzle group is arranged at a uniform nozzle pitch k·D along a sub-scanning direction SS, where k is an integer and D is a pitch (referred to as “a dot pitch”) corresponding to a print resolution in the sub-scanning direction. In the specification, “the nozzle pitch is also referred to as a k dot”. At this time, a unit of [dot] means a dot pitch of the print resolution. The unit of [dot] is likewise used for an amount of transport. In the first embodiment, 180 nozzles are provided in each of the nozzle rows and the dot pitch is 720 dots. Accordingly, the nozzle pitch is four dots (where k=4). That is, in the first embodiment, the plurality of nozzles is arranged at an interval of four dots.

Each of the nozzles is provided with a piezo element (not shown) as a driving element that ejects ink droplets by driving each nozzle. In the printing process, the ink droplets are ejected from the nozzles, while the print head 28 is moved in a main scanning direction MS. The printer 20 according to the first embodiment is a printer that performs a bi-direction printing process. That is, the printing head 28 forms dots in respective main scanning processes of a going movement and a coming movement.

The plurality of nozzles of each nozzle group is not required to be arranged in a straight line along the sub-scanning direction. For example, the nozzles may be arranged in a zigzag shape. When the nozzles are arranged in the zigzag shape, the nozzle pitch k·D measured in the sub-scanning direction can be also defined in the same manner as the case shown in FIG. 4.

The color printer 20 having the above-described hardware configuration allows the carriage motor 24 to reciprocate the carriage 30 while allowing the sheet feeding motor 22 to transport the print sheet P. Simultaneously, the color printer ejects respective color ink droplets to form an image with multiple colors and multiple gray scales on the print sheet P by driving the piezo elements of the recording head 28.

### A2. Printing Method

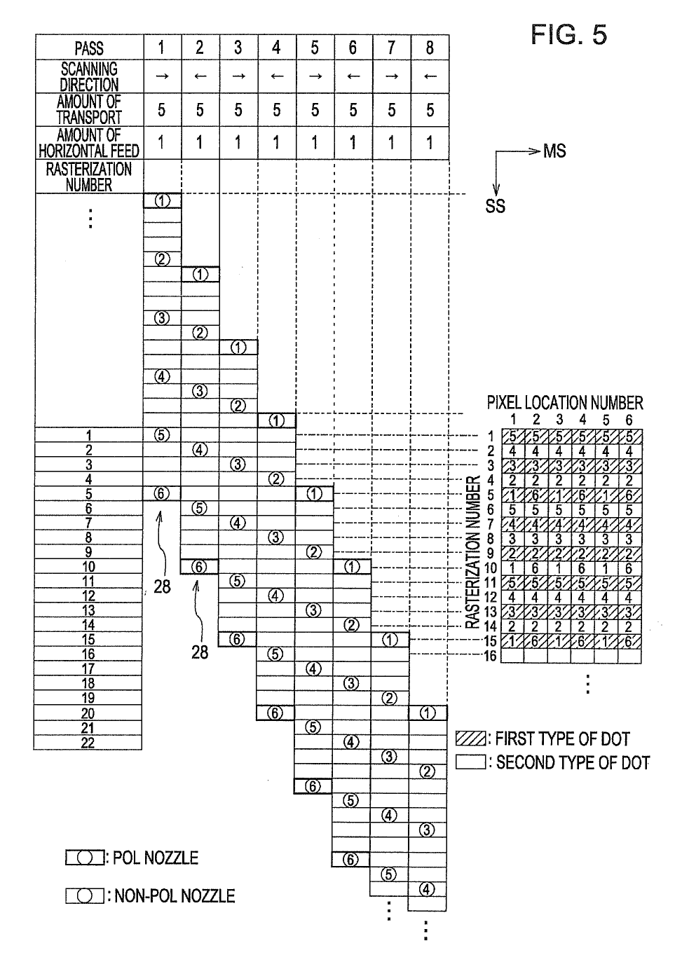

FIG. 5 is an explanatory diagram illustrating a printing process when an overlap recording method is applied to a known bi-direction printing process. The overlap recording method refers to a recording method of forming dots of a predetermined raster line by use of two or more nozzles arranged at different locations in the sub-scanning direction. In the specification, a raster line formed by use of two or more nozzles arranged at different locations in the sub-scanning direction is referred to as an overlap raster (OL raster). In addition, nozzles used to form the OL raster are referred to as overlap nozzles (OL nozzles). In the overlap recording method, there are a full overlap recording method of recording all the raster lines in a manner of the overlap method and a partial overlap (POL) recording method of recording some of the raster lines in the manner of the overlap method. In FIG. 5, the POL recording method will be described. In the specification, the OL raster formed in the POL recording method is referred to as a POL raster and the nozzles used to form the POL raster are referred to as POL nozzles. In FIG. 5, a nozzle surrounded by a full bold line outline represents the POL nozzle and a nozzle surrounded by a full thin line outline represents a nozzle (a non-POL nozzle) forming all dots of one raster line by a one-time scanning process.

In FIG. 5, an example of a sub-scanning feeding process using six nozzles and parameters of the POL recording method are shown. In FIG. 5, a full line circle containing a numeral surrounded by a rectangular outline represents the locations of the six nozzles in the sub-scanning direction in each pass. Here, “the pass” means a one-time main-scanning process (the going movement or the coming movement). “The amount of transport” means an amount of a one-time sub-scanning process. The amount of transport is represented by the number of dots. Numerals 1 to 6 in the circles mean a nozzle number. The locations of the six nozzles are moved in the sub-scanning direction whenever the one-time main scanning process ends. Actually, the feeding process in the sub-scanning direction is realized by allowing the sheet feeding motor 22 (see FIG. 2) to move the sheet. “A scanning direction” represents a movement direction of the recording head 28 in the main scanning direction. A rightward arrow represents the scanning process in the going movement (odd-numbered pass) and a leftward arrow represents the scanning process in the coming movement (even-numbered pass). In this way, the dots are formed with the scanning process in the going movement and the coming movement.

In the example shown in FIG. 5, an amount L of transport is a uniform value of five dots. Accordingly, when the sub-scanning feeding process is performed, each of the locations of the six nozzles is deviated in the sub-scanning direction by five dots. For each nozzle, all the dot locations (also referred to as “a pixel location”) of each raster line during one-time main scanning process are recording targets.

In FIG. 5, an image 300 formed on the print sheet P is also shown. The image 300 is an image having the width of six dots in the main scanning direction. A pixel location number represents the location of each pixel in the main scanning direction. A raster number represents the location of each raster in the sub-scanning direction. Hereinafter, each raster line is denoted by a number. For example, a raster line of which the raster number is 3 is denoted by raster line 3. In addition, each pixel is denoted by the pixel location number. For example, a pixel of which the pixel location number is 3 is denoted by pixel location 2. In the image 300, one rectangle represents one dot (one pixel). The image 300 has a width of six dots in the main scanning direction. As for the dots, the dots formed in the going movement of the recording head 28 are formed by ejecting a liquid from the nozzles in a movement direction (from the left side to the right side in FIG. 5) of the going movement and the dots formed in the coming movement of the recording head 28 are formed by ejecting a liquid from the nozzles in a movement direction (from the right side to the left side in FIG. 5) of the coming movement. Accordingly, the dots formed on the recording medium upon the going movement and the dots formed on the recording medium upon the coming movement are different from each other in a direction in which ink is printed. Hereinafter, in the specification, the direction in which ink of the dots are printed is referred to as “a filling direction”. Hereinafter, in the specification, a dot formed when the filling direction is the direction of the going movement is referred to as a first type of dot and the dot formed when the filling direction is the direction of the coming movement is referred to as a second type of dot.

In FIG. 5, the nozzle numbers of the nozzles recording the dots of each raster line are shown. In an area of raster line 1, the dots are just formed in the raster line in an intermittent manner, since ink is not ejected from POL nozzle 6 corresponding to POL nozzle 1. Accordingly, in order to prevent the quality of an image from deteriorating, the recording of the dot is actually banned. On the other hand, after raster line 1, in the raster lines formed in the overlap method, the dots are formed without a gap by POL nozzle 1 and POL nozzle 6. In addition, in the other raster lines, the dots are formed without a gap by one non-POL nozzle.

As shown in raster line 5 and raster line 10 of the image 300, the raster lines are formed at an interval of five dots in the sub-scanning direction by alternately forming the dots from the nozzle of nozzle number 1 and the nozzle of nozzle number 6 as the POL nozzles. As shown in the image 300, the raster line other than the POL raster is formed by one non-POL nozzle. Hereinafter, in the specification, the raster line formed by the non-POL nozzle is referred to as a non-POL raster.

The filling direction of the dots of the image 300 will be described. In a known POL recording method, as shown in the image 300, all the odd-numbered raster lines are formed by the first type of dots and all the even-numbered raster lines are formed by the second type of dots, irrespective of whether the raster line is the POL raster or the non-POL raster.

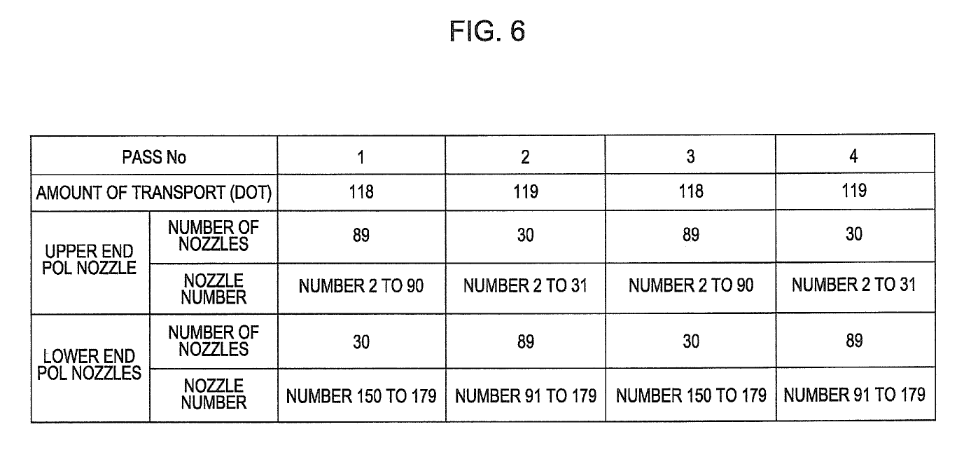

In FIGS. 5 and 6, the case where the amount L of transport is a uniform value has been described, but a plurality of different values may be used as the amount of transport. In the specification, the sub-scanning feeding process in which the amount L of transport is uniform is referred to as “a normal feeding process”. In addition, the sub-scanning feeding process in which the plurality of different values is used as the amount L of transport is referred to as “an anomalous feeding process”.

A3. Allocation of POL Nozzles in each Scanning Process

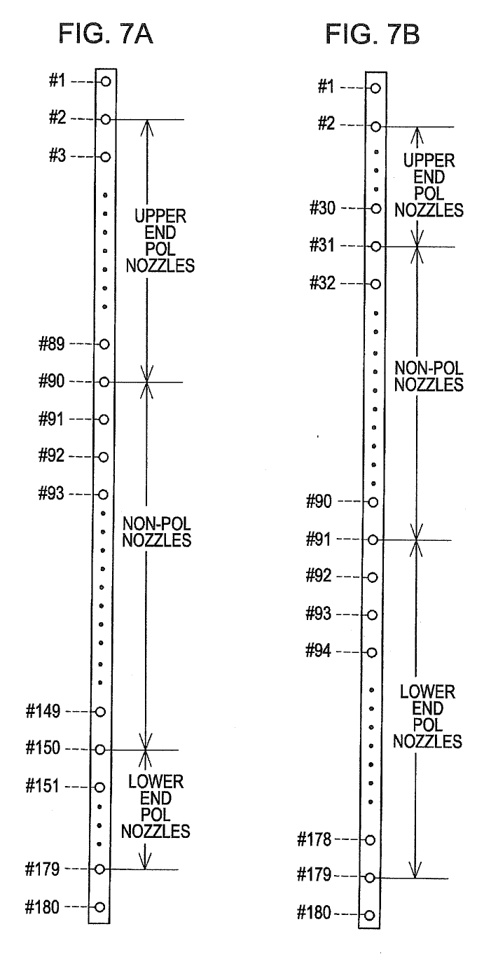

FIG. 6 is a table showing allocation of the POL nozzles in each main scanning process according to the first embodiment. FIG. 7 is a schematic diagram illustrating the POL nozzles according to the first embodiment. In the first embodiment, when the POL recording method in the bi-direction printing process is applied, the allocation of the POL nozzles is changed into the even-numbered scanning process and the odd-numbered scanning process, that is, the odd-numbered pass (upon the going movement) and the even-numbered pass (upon the coming movement) of the recording head 28. In FIG. 6, “upper end POL nozzles” refer to the POL nozzles provided in the upper end of each nozzle row of the recording head 28 and “lower end POL nozzles” refer to the POL nozzles provided in the lower end of each nozzle row of the recording head 28. “A nozzle number” of the upper end POL nozzles refers to the number of the upper end POL nozzles and “a nozzle number” of the upper end POL nozzles refers to the nozzle number of the upper end POL nozzles. Likewise, “a nozzle number” of the lower end POL nozzles refers to the number of the lower end POL nozzles and “a nozzle number” of the lower end POL nozzles refers to the nozzle number of lower end POL nozzles. (a) of FIG. 7 shows the POL nozzles upon the going movement of the recording head 28 and (b) of FIG. 7 shows the POL nozzles upon the coming movement of the recording head 28.

As shown with reference to FIGS. 6 and 7, in the printer 20 according to the first embodiment, in the odd-numbered pass, the total eighty nine nozzles of nozzles 2 to 90 provided in the upper end of each nozzle row of the recording head 28 are allocated as the upper end POL nozzles, and the total thirty nozzles of nozzles 150 to 179 provided in the lower end of each nozzle row of the recording head 28 are allocated as the lower end POL nozzles. In addition, in the even-numbered pass, the total thirty nozzles of nozzles 2 to 31 provided in the upper end of each nozzle row of the recording head 28 are allocated as the upper end POL nozzles, and the total eighty nine nozzles of nozzles 91 to 179 provided in the lower end of each nozzle row of the recording head 28 are allocated as the lower end POL nozzles. In this way, the number of the POL nozzles is alternated in the odd-numbered pass and the even-numbered pass.

In the first embodiment, the print sheet is transported in the sub-scanning direction by the anomalous feeding process. As shown in FIG. 6, the print sheet is transported in the sub-scanning direction by 118 dots after end of the even-numbered pass. In addition, after end of the even-numbered pass, the print sheet is transported in the sub-scanning direction by 119 dots.

As described with reference to FIGS. 6 and 7, the printer 20 according to the first embodiment changes the allocation of the POL nozzles in every one-time scanning process and forms an image on the print sheet P by varying the amount of transport in the sub-scanning direction.

### A4. Printing Method

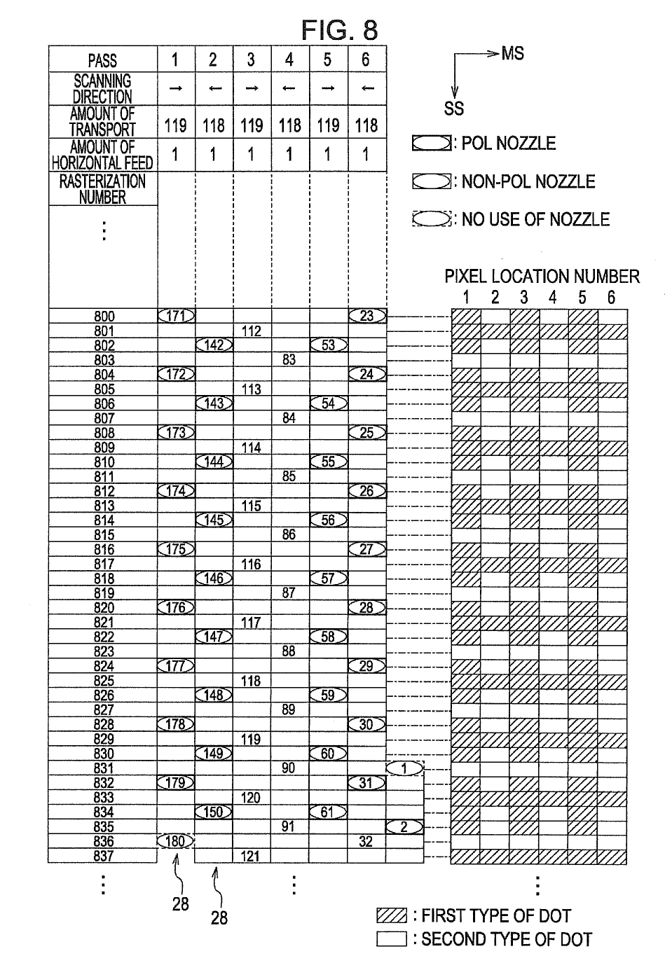

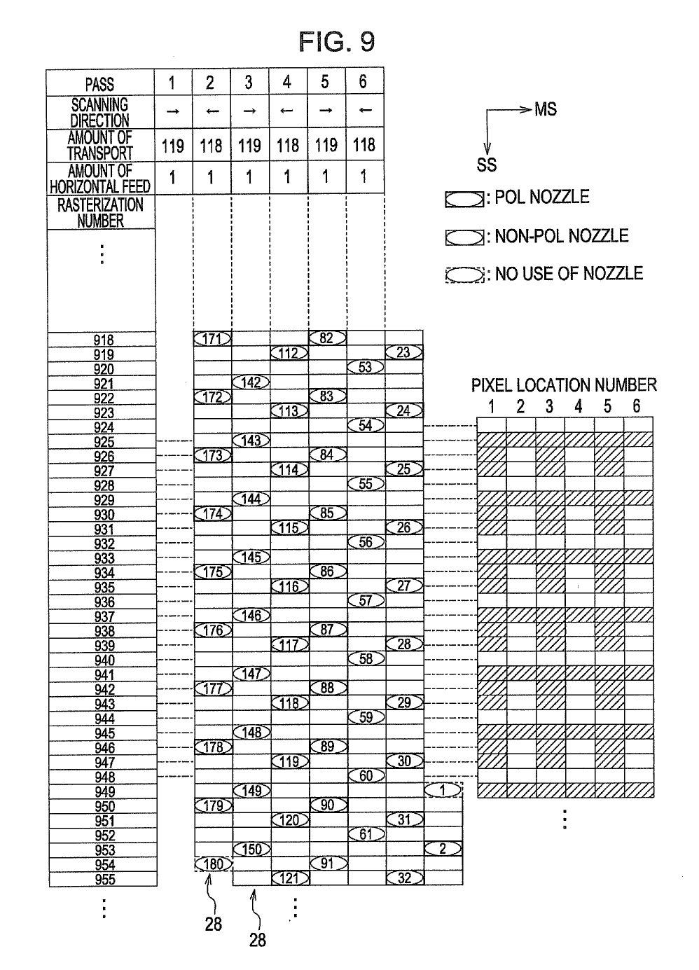

FIGS. 8 and 9 are explanatory diagrams illustrating the printing method according to the first embodiment. In FIG. 8, the same signs or hatching as those of FIG. 5 have the same meaning. FIG. 8 shows the raster lines of raster number 800 to 837. FIG. 9 shows the raster lines of raster number 918 to 955. The raster number is just attached with the number is attached and does not refer to the location of the raster in the sub-scanning direction which is actually printed.

In the first embodiment, the POL raster is formed by alternately arranging the pixels (the first type of dots) upon the going movement and the pixel (the second type of dots) upon the coming movement. The alternate formation of the first dot and the second dot can be realized by controlling the amount of transport of the print sheet P and the amount of feed in a horizontal direction (the main scanning direction) of the recording head, for example. In the first embodiment, since the amount of feed in the horizontal direction is one dot, the first type of dot and the second type of dot are alternately formed every two dots. In addition, the amount of feed in the horizontal direction is not limited to the one dot, but may be several dots. Alternatively, the amount of feed may be varied by three dots in the odd-numbered pass and by two dots in the even-numbered pass in each pass. “The alternately arranging of the pixel upon the going movement and the pixel upon the coming movement” is not limited to every two dots, but the first type of dots and the second type of dots may be regularly arranged in an alternate manner. The amount of transport is appropriately determined in accordance with the number of the POL nozzles or the location of the POL nozzles. The amount of transport in the anomalous feeding process is appropriately determined in accordance with various conditions such as the number of nozzles, the nozzle pitch, the dot pitch, and a ratio of the POL rasters to all the raster lines.

For example, as shown in FIGS. 8 and 9, the POL raster and the non-POL raster are alternately formed, and the first type of dots and the second type of dots are alternately formed in the POL raster. That is, the dots formed in the opposing filling directions are alternately formed in the POL raster.

In the first embodiment, the allocation of the POL nozzles is changed in the odd-numbered pass and the even-numbered pass, and the combination of the POL nozzles for forming the POL raster is changed by performing the anomalous feeding process of the print sheet P. The change in the combination of the POL nozzles will be described in focus of nozzle 171.

For example, as shown in FIG. 8, in a first pass, POL nozzle 171 forms the first type of dots at pixel locations 1, 3, and 5 of the raster of raster number 800 by allowing the recording head 28 to make the going movement. When the scanning process of the first pass ends, the print sheet P is transported in the sub-scanning direction by 119 dots. As shown in FIG. 9, in a second pass, the second type of dots are formed at pixel locations 2, 4, and 6 of the raster line of raster number 918 by allowing the recording head 28 to make the coming movement. Description of third and fourth passes is omitted.

When the fourth pass ends and the print sheet P is transported in the sub-scanning direction by 118 dots, the locations of the nozzles in a fifth pass are relatively deviated from the locations of the nozzles in the second pass in the sub-scanning direction by 356 dots. In the first embodiment, since the nozzle pitch k=4 dots, a relation of 356 dots/4 dots=89 is satisfied. Accordingly, the upper end POL nozzle which is nozzle 82 located in the upper end by eighty nine nozzles than POL nozzle 171 forms the first type of dots at pixel locations 1, 3, and 5 of the raster of raster number 918. In consequence, the first type of dots and the second type of dots are alternately formed in the raster line of raster number 918. That is, the dots formed in the opposing filling directions are alternately formed in the POL raster.

When the fifth pass ends and the print sheet P is transported by 119 dots in the sub-scanning direction, the locations of the nozzles in a sixth pass are relatively deviated from the locations of the nozzles in the first pass in the sub-scanning direction by 592 dots. Accordingly,, since a relation of 592 dots/4 dots=148 is satisfied, the upper end POL nozzle which is nozzle 23 located in the upper end by 148 nozzles than POL nozzle 171 forms the first type of dots at pixel locations 2, 4, and 6 of the raster of raster number 800.

The POL raster of raster number 800 is formed by a combination of POL nozzle 171 which is the lower end POL nozzle in the first pass and POL nozzle 23 which is the upper end POL nozzle in the sixth pass. In addition, the POL raster of raster number 918 is formed by a combination of POL nozzle 171 which is the lower end POL nozzle in the second pass and POL nozzle 82 which is the upper end POL nozzle in the fifth pass. In this way, the combination of the POL nozzles forming the POL raster is changed.

In the first embodiment, the numbers of the upper end and lower end POL nozzles alternated in the odd-numbered pass and the even-numbered pass are limited to thirty nozzles and eighty nine nozzles, respectively. The invention is not also limited to the anomalous feeding process in which the print sheet is transported alternately by the amount of transport of 118 dots and 119 dots. The number of POL nozzles, the locations of the POL nozzles, and the amount of transport in the anomalous feeding process are appropriately determined in accordance with various conditions such as the number of nozzles, the nozzle pitch, the dot pitch, and a ratio of the POL rasters to all the raster lines.

In the printer according to the above-described first embodiment, two types of dots formed in the different filling directions, that is, the dots formed by printing the liquid in the direction of the going movement and the dots formed by printing the liquid in the direction of the coming movement are contained in one POL raster. Accordingly, it is possible to prevent a noise from occurring in the main scanning direction and to improve the quality of an image formed on the print medium.

In the printer according to the first embodiment, in the POL raster, the types of dots formed in the different filling directions are alternately formed in the main scanning direction in every two dots. Accordingly, it is possible to restrain the occurrence of the noise with a high precision.

In the printer according to the first embodiment, in the bi-direction printing process to which the partial overlap method is applied, the anomalous feeding process is performed on the print sheet P and the number of the upper end and lower end POL nozzles are alternated in the odd-numbered pass and the even-numbered pass. Accordingly, since the combination of the nozzles forming the raster can be changed, it is possible to prevent the quality of an image from deteriorating due to a nozzle manufacturing error.

In the printer according to the first embodiment, the POL raster is formed by the dots ejected in the non-continuous main scanning process. Accordingly, in the POL raster, ones of the first type of dots and the second type of dots are formed, and then after some time passes, the others thereof are formed. During the some time, the ones initially formed in the POL raster are dried. Accordingly, it is possible to prevent the adjacent dots from being mixed and sinking.

### B. Second Embodiment

Like the first embodiment, in a second embodiment, a printer that performs the anomalous feeding process and changes the POL nozzles in every pass upon applying the POL recording method in the bi-direction printing process and that performs the printing process will be described. However, in the second embodiment, the amount of transport in the odd-numbered pass and the even-numbered pass is different by five dots. In the second embodiment, a recording head having six nozzles will be described as an example in order to simplify the drawing.

### B1. Printing Method

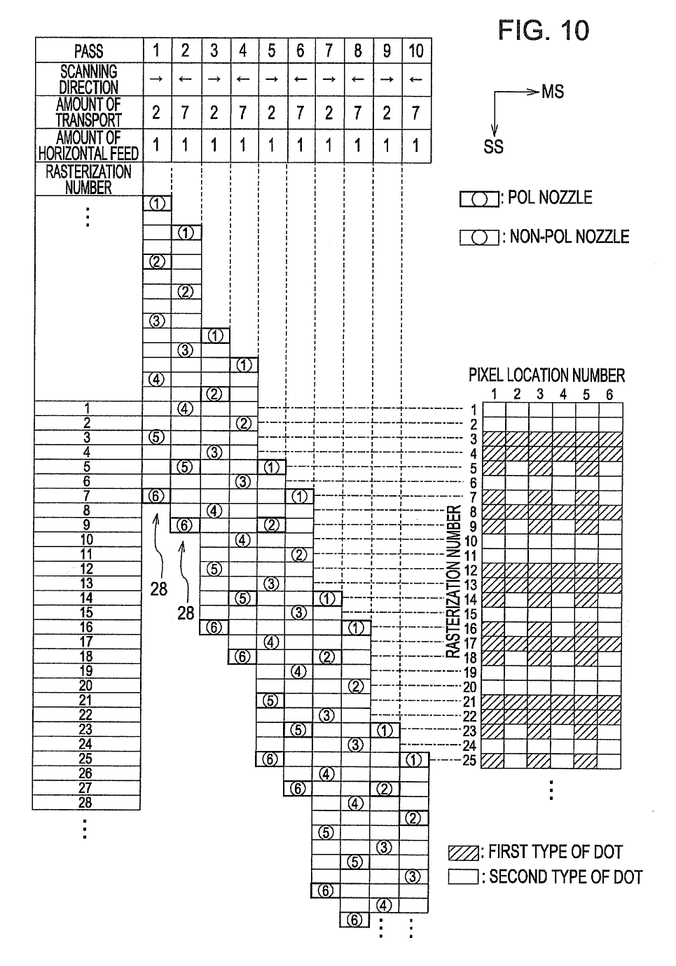

FIG. 10 is an explanatory diagram illustrating a printing method according to the second embodiment. In FIG. 10, the same reference numerals, signs, and hatching as those of FIG. 5 have the same meaning. In the second embodiment, as shown in FIG. 10, the nozzle pitch (=k) is four dots. In the odd-numbered pass, two nozzles 1 and 2 provided in the upper end of each nozzle row of the recording head 28 are allocated as the upper end POL nozzles and one nozzle 6 provided in the lower end of each nozzle row of the recording head 28 is allocated as the lower end POL nozzle. In addition, in the even-numbered pass, one nozzle 1 provided in the upper end of each nozzle row of the recording head 28 is allocated as the upper end POL nozzle and two nozzles 5 and 6 provided in the lower end of each nozzle row of the recording head 28 are allocated as the lower end POL nozzles. In this way, the number of the POL nozzles is alternated in the odd-numbered pass and the even-numbered pass like the first embodiment.

As shown in FIG. 10, in a first pass, POL nozzle 6 forms the first type of dots at pixel locations 1, 3, and 5 of raster line 7 by allowing the recording head 28 to make the going movement. When the scanning process of the first pass ends, the print sheet P is transported in the sub-scanning direction by two dots. In a second pass, POL nozzle 6 forms the second type of dots at pixel locations 2, 4, and 6 of raster line 9 by allowing the recording head 28 to make the coming movement. Description of third and fourth passes is omitted.

When the fourth pass ends and the print sheet P is transported in the sub-scanning direction by seven dots, nozzle 2 is located in raster line 9 on the basis of the nozzle pitch and the amount of transport in a fifth pass. The description of the first embodiment can be likewise applied to the locations of the nozzles in accordance with the nozzle pitch and the amount of transport. Since nozzle 2 is allocated to the POL nozzle upon the going movement and not allocated to the POL nozzle upon the coming movement, the first type of dots are formed at pixel locations 1, 3, and 5 of raster line 9. In consequence, the first type of dots and the second type of dots are alternately formed in raster line 9. That is, the dots formed in the opposing filling directions are alternately formed in the POL raster.

When the fifth pass ends and the print sheet P is transported in the sub-scanning direction by two dots, nozzle 1 is located in raster line 7 on the basis of the nozzle pitch and the amount of transport in a sixth pass. Since nozzle 1 is allocated to the POL nozzle upon the going movement and the coming movement, the second type of dots are formed at pixel locations 2, 4, and 6 of raster line 7. In consequence, the first type of dots and the second type of dots are alternately formed in raster line 7.

In the odd-numbered pass, nozzles 3 to 5 form all the dots of one raster line in one-time scanning process. In addition, in the even-numbered pass, nozzles 2 to 4 form all the dots of one raster line in one-time scanning process.

Accordingly, raster line 7 is formed by a combination of POL nozzle 6 which is the lower end POL nozzle in the first pass and POL nozzle 1 which is the upper end POL nozzle in the sixth pass. In addition, the POL raster of raster line 9 is formed by a combination of POL nozzle 6 which is the lower end POL nozzle in the second pass and POL nozzle 2 which is the upper end POL nozzle in the fifth pass. In this way, the combination of the POL nozzles forming the POL raster is changed.

In the printer according to the above-described second embodiment, since the nozzles (nozzles 1 and 6) in the end where banding easily occurs are the POL nozzles, it is possible to restrain the occurrence of the noise with a high precision.

According to the second embodiment, the first type of dots and the second type dots can be contained in the POL raster, even when the amount of transport in the odd-numbered pass is deviated than that in the even-numbered pass by one or more dots. Accordingly, it is possible to improve the quality of an image formed on the recording medium.

### C. Third Embodiment

Like the first embodiment, in a third embodiment, a printer that performs the anomalous feeding process and changes the POL nozzles in every pass upon applying the POL recording method in the bi-direction printing process and that performs the printing process will be described. However, in the second embodiment, when the odd-numbered pass ends, the print sheet P is transported in the sub-scanning direction by five dots. In addition, when the even-numbered pass ends, the print sheet is transported in the sub-scanning direction by two dots. In the third embodiment, a recording head having six nozzles will be described as an example in order to simplify the drawing.

### C1. Printing Method

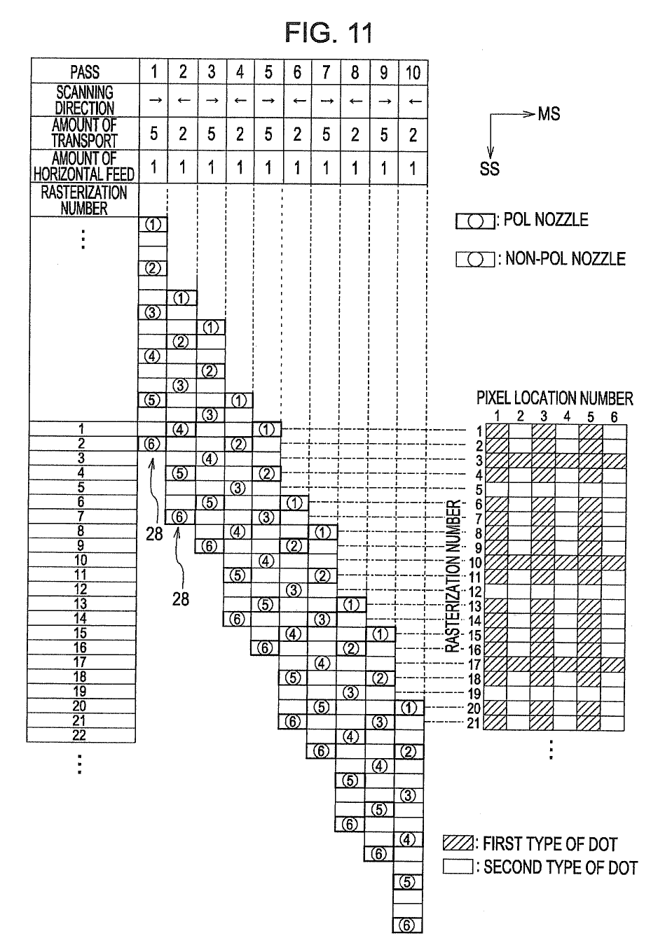

FIG. 11 is an explanatory diagram illustrating a printing method according to the third embodiment. In FIG. 11, the same reference numerals, signs, and hatching as those of FIG. 5 have the same meaning. In the third embodiment, as shown in FIG. 11, the nozzle pitch (=k) is three dots. In the odd-numbered pass, three nozzles 1 to 3 provided in the upper end of each nozzle row of the recording head 28 are allocated as the upper end POL nozzles and two nozzles 5 and 6 provided in the lower end of each nozzle row of the recording head 28 are allocated as the lower end POL nozzle. In addition, in the even-numbered pass, two nozzles 1 and 2 provided in the upper end of each nozzle row of the recording head 28 are allocated as the upper end POL nozzles and three nozzles 4 to 6 provided in the lower end of each nozzle row of the recording head 28 are allocated as the lower end POL nozzles. In this way, the number of the POL nozzles is alternated in the odd-numbered pass and the even-numbered pass like the first embodiment.

As shown in FIG. 11, in a first pass, POL nozzle 6 forms the first type of dots at pixel locations 1, 3, and 5 of raster line 2 by allowing the recording head 28 to make the going movement. When the scanning process of the first pass ends, the print sheet P is transported in the sub-scanning direction by five dots. In a second pass, POL nozzle 6 forms the second type of dots at pixel locations 2, 4, and 6 of raster line 7 by allowing the recording head 28 to make the coming movement. Description of third pass is omitted.

When the third pass ends and the print sheet P is transported in the sub-scanning direction by five dots, nozzle 2 is located in raster line 2 on the basis of the nozzle pitch and the amount of transport in a fourth pass. The description of the first embodiment made with reference to FIGS. 8 and 9 can be likewise applied to the locations of the nozzles in accordance with the nozzle pitch and the amount of transport. Nozzle 2 is the POL nozzle and forms the second type of dots at pixel locations 2, 4, and 6 of raster line 2. In consequence, the first type of dots and the second type of dots are alternately formed in raster line 9. That is, the dots formed in the opposing filling directions are alternately formed in the POL raster.

When the fourth pass ends and the print sheet P is transported in the sub-scanning direction by two dots, nozzle 3 is located in raster line 7 on the basis of the nozzle pitch and the amount of transport in a fifth pass. Since nozzle 1 is allocated as the POL nozzle in the odd-numbered pass, the first type of dots are formed at pixel locations 1, 3, and 5 of raster line 7. In consequence, the first type of dots and the second type of dots are alternately formed in raster line 7.

In the odd-numbered pass, nozzle 4 forms all the dots of one raster line in one-time scanning process. In addition, in the even-numbered pass, nozzle 3 forms all the dots of one raster line in one-time scanning process.

Accordingly, the POL raster of raster line 7 is formed by a combination of POL nozzle 6 which is the lower end POL nozzle in the first pass and POL nozzle 1 which is the upper end POL nozzle in the sixth pass. In addition, the POL raster of raster line 9 is formed by a combination of POL nozzle 6 which is the lower end POL nozzle in the second pass and POL nozzle 2 which is the upper end POL nozzle in the fifth pass. In this way, the combination of the POL nozzles forming the POL raster is changed.

In the printer according to the above-described third embodiment like the second embodiment, since the nozzles (nozzles 1 and 6) in the end where banding easily occurs are the POL nozzles, it is possible to restrain the occurrence of the noise with a high precision. Since the five nozzles among all the six nozzles are the POL nozzles, it is possible to improve the quality of an image.

### D. Fourth Embodiment

In the first to third embodiments, the control process performed when the POL recording method is applied in the bi-direction printing process has been described. In a fourth embodiment, a control process performed when a full overlap (FOL) recording method in which all the nozzles are the OL nozzles and all the raster lines are the OL rasters is applied will be described. In the fourth embodiment, a printer that performs the anomalous feeding process upon applying the FOL recording method in the bi-direction printing process and performs a printing process will be described. The configuration of the printer is the same as that of the first embodiment. However, in the fourth embodiment, when the odd-numbered pass ends, the print sheet P is transported in the sub-scanning direction by three dots. In addition, when the even-numbered pass ends, the print sheet is transported in the sub-scanning direction by two dots. In the fourth embodiment, a recording head having five nozzles will be described as an example in order to simplify the drawing.

### D1. Printing Method

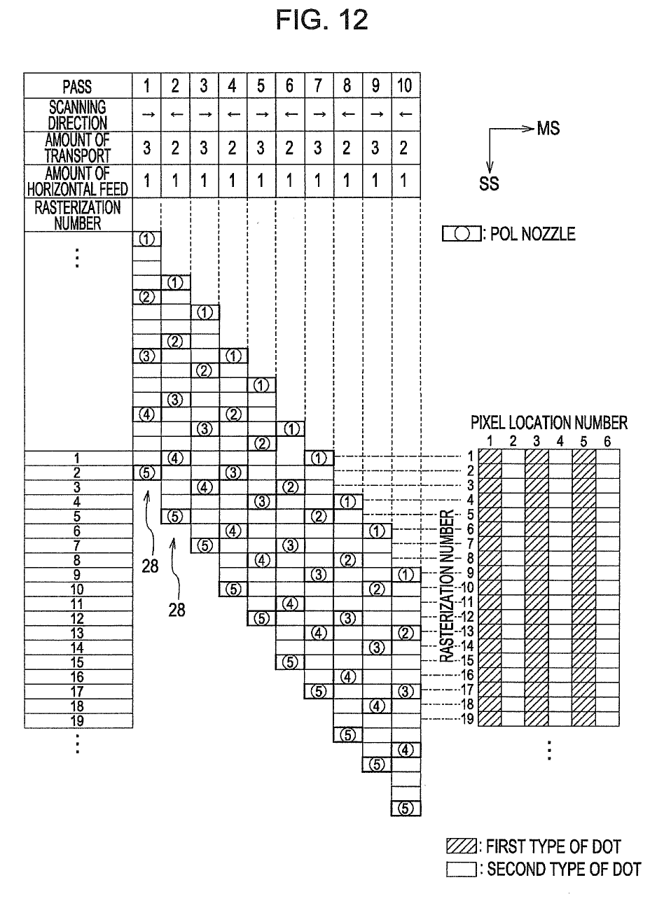

FIG. 12 is an explanatory diagram illustrating a printing method according to the fourth embodiment. In FIG. 12, the same reference numerals, signs, and hatching as those of FIG. 5 have the same meaning. In the third embodiment, as shown in FIG. 12, the nozzle pitch (=k) is four dots. In addition, as indicated by a full bold line outline, all the nozzles are used as the OL nozzles.

As shown in FIG. 12, in a first pass, OL nozzle 5 forms the first type of dots at pixel locations 1, 3, and 5 of raster line 2 by allowing the recording head 28 to make the going movement. When the scanning process of the first pass ends, the print sheet P is transported in the sub-scanning direction by three dots. In a second pass, OL nozzle 5 forms the second type of dots at pixel locations 2, 4, and 6 of raster line 5 by allowing the recording head 28 to make the coming movement. Description of a third pass is omitted.

When the third pass ends and the print sheet P is transported in the sub-scanning direction by three dots, nozzle 3 is located in raster line 2 on the basis of the nozzle pitch and the amount of transport in a fourth pass. The description of the first embodiment made with reference to FIGS. 8 and 9 can be likewise applied to the location of the nozzle in accordance with the nozzle pitch and the amount of transport. Since nozzle 3 is the OL nozzle, the nozzle forms the second type of dots at pixel locations 2, 4, and 6 of raster line 2. In consequence, the first type of dots and the second type of dots are alternately formed in raster line 2. The description of fourth to sixth passes is omitted.

When the sixth pass ends and the print sheet P is transported in the sub-scanning direction by two dots, nozzle 2 is located in raster line 5 on the basis of the nozzle pitch and the amount of transport in a seventh pass. Since nozzle 2 is the OL nozzle, the nozzle forms the first type of dots at pixel locations 1, 3, and 5 of raster line 5. In consequence, the first type of dots and the second type of dots are alternately formed in raster line 5.

Accordingly, the OL raster of raster line 2 is formed by a combination of nozzle 5 in the first pass and nozzle 3 in the fourth pass. In addition, the OL raster of raster line 5 is formed by a combination of nozzle 5 in the second pass and nozzle 2 in the seventh pass. In this way, the combination of the nozzles forming the OL raster is changed.

In the printer according to the above-described fourth embodiment, the dots in the different filling directions are alternately formed in all the raster lines. Accordingly, it is possible to improve the quality of an image formed on the recording medium.

### E. Fifth Embodiment

Like the fourth embodiment, in a fifth embodiment, a printer that performs the anomalous feeding process upon applying the FOL recording method in the bi-direction printing process and performs a printing process will be described. However, in the fifth embodiment, when the odd-numbered pass ends, the print sheet P is transported in the sub-scanning direction by one dot. In addition, when the even-numbered pass ends, the print sheet is transported in the sub-scanning direction by two dots. In the fifth embodiment, a recording head having three nozzles will be described as an example in order to simplify the drawing. The configuration of the printer is the same as that of the first embodiment.

### E1. Printing Method

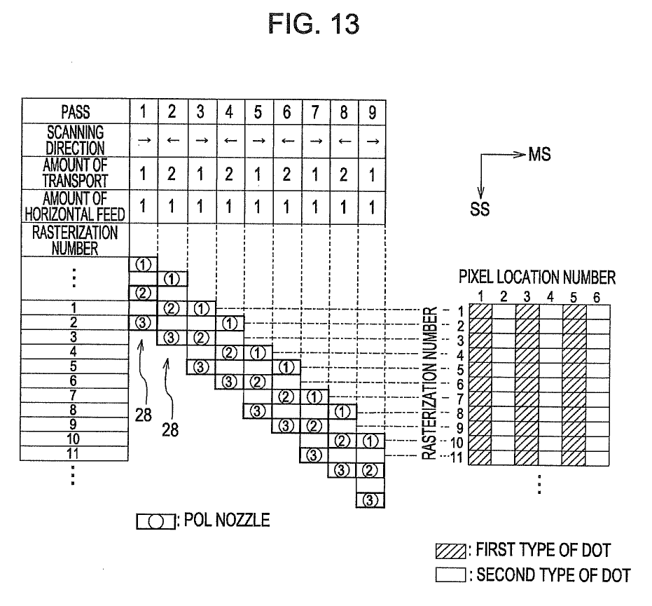

FIG. 13 is an explanatory diagram illustrating a printing method according to the fifth embodiment. In FIG. 13, the same reference numerals, signs, and hatching as those of FIG. 5 have the same meaning. In the third embodiment, as shown in FIG. 13, the nozzle pitch (=k) is two dots. In addition, as indicated by a full bold line outline, all the nozzles are used as the OL nozzles.

As shown in FIG. 13, in a first pass, nozzle 3 forms the first type of dots at pixel locations 1, 3, and 5 of raster line 2 by allowing the recording head 28 to make the going movement. When the scanning process of the first pass ends, the print sheet P is transported in the sub-scanning direction by one dot. In a second pass, nozzle 3 forms the second type of dots at pixel locations 2, 4, and 6 of raster line 3 by allowing the recording head 28 to make the coming movement.

When the second pass ends and the print sheet P is transported in the sub-scanning direction by two dots, nozzle 2 is located in raster line 3 on the basis of the nozzle pitch and the amount of transport in a third pass. The description of the first embodiment made with reference to FIGS. 8 and 9 can be likewise applied to the location of the nozzle in accordance with the nozzle pitch and the amount of transport. Nozzle 2 forms the first type of dots at pixel locations 1, 3, and 5 of raster line 3. In consequence, the first type of dots and the second type of dots are alternately formed in raster line 3.

When the third pass ends and the print sheet P is transported in the sub-scanning direction by one dot, nozzle 1 is located in raster line 2 on the basis of the nozzle pitch and the amount of transport in a fourth pass. Nozzle 1 forms the second type of dots at pixel locations 2, 4, and 6 of raster line 2. In consequence, the first type of dots and the second type of dots are alternately formed in raster line 2.

Accordingly, raster line 2 is formed by a combination of nozzle 3 in the first pass and nozzle 1 in the fourth pass. In addition, raster line 3 is formed by a combination of nozzle 3 in the second pass and nozzle 2 in the third pass. In this way, the combination of the nozzles forming the raster line is changed.

In the printer according to the above-described fifth embodiment, the dots in the different filling directions are alternately formed in all the raster lines. Accordingly, it is possible to improve the quality of an image.

### F. Sixth Embodiment

In a sixth embodiment, a printer that performs the normal feeding process upon applying the POL recording method in the bi-direction printing process and performs a printing process will be described. In the sixth embodiment, the anomalous feeding process and the change in the allocation of the POL nozzles are not performed. The configuration of the printer is the same as that of the first embodiment. In the sixth embodiment, when the pass ends, the print sheet P is transported in the sub-scanning direction by four dots. In the sixth embodiment, a recording head having six nozzles will be described as an example in order to simplify the drawing.

### F1. Printing Method

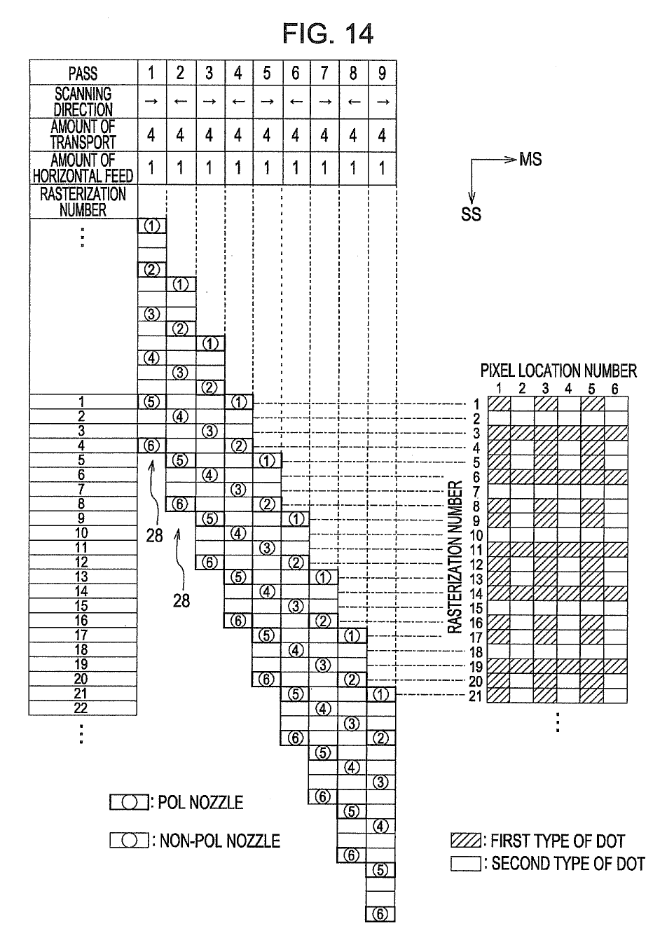

FIG. 14 is an explanatory diagram illustrating a printing method according to the sixth embodiment. In FIG. 14, the same reference numerals, signs, and hatching as those of FIG. 5 have the same meaning. In the sixth embodiment, as shown in FIG. 14, the nozzle pitch (=k) is three dots. In addition, as indicated by a full bold line outline, two nozzles 1 and 2 provided in the upper end of each nozzle row of the recording head 28 are allocated as the upper end POL nozzles. In addition, two nozzles 5 and 6 provided in the lower end of each nozzle row of the recording head 28 are allocated as the lower end POL nozzles.

As shown in FIG. 14, in a first pass, nozzle 6 forms the first type of dots at pixel locations 1, 3, and 5 of raster line 4 by allowing the recording head 28 to make the going movement. When the scanning process of the first pass ends, the print sheet P is transported in the sub-scanning direction by four dots. In a second pass, nozzle 6 forms the second type of dots at pixel locations 2, 4, and 6 of raster line 8 by allowing the recording head 28 to make the coming movement. Description of a third pass is omitted.

When the third pass ends and the print sheet P is transported in the sub-scanning direction by four dots, nozzle 2 is located in raster line 4 in a fourth pass. Since nozzle 2 is the POL nozzle, the nozzle forms the second type of dots at pixel locations 2, 4, and 6 of raster line 4. In consequence, the first type of dots and the second type of dots are alternately formed in raster line 4.

When the fourth pass ends and the print sheet P is transported in the sub-scanning direction by four dots, nozzle 2 is located in raster line 8 in a fifth pass. Nozzle 2 forms the first type of dots at pixel locations 1, 3, and 5 of raster line 8. In consequence, the first type of dots and the second type of dots are alternately formed in raster line 8.

As described above, the amount of transport is uniform four dots and the POL nozzles are not changed. Therefore, the combination of nozzles 6 and 2 forming the POL raster is not changed and the POL raster is formed by the combination of nozzles 6 and 2 at an interval of four raster lines after raster line 4. Likewise, the combination of nozzles 5 and 1 forming the POL raster is not changed and the POL raster is formed by the combination of nozzles 5 and 1 at an interval of four raster lines after raster line 1.

In each pass, nozzles 3 and 4 form all the dots of one raster line in one-time scanning process.

In the printer according to the above-described sixth embodiment, in the bi-direction printing process to which the partial overlap method is applied, the normal feeding process of the print sheet P is performed so that the two kinds of dots formed in the different filling directions, that is, the dots formed by printing the liquid in the direction of the going movement and the dots formed by printing the liquid in the direction of the coming movement are contained in one POL raster. Accordingly, since a noise occurring in the main scanning direction can be prevented, it is possible to improve the quality of an image formed on the recording medium.

### C. Seventh Embodiment

Like the seventh embodiment, in a seventh embodiment, a printer that performs the normal feeding process upon applying the POL recording method in the bi-direction printing process and performs a printing process will be described. In the seventh embodiment, the anomalous feeding process and the change in the allocation of the POL nozzles are not performed. The configuration of the printer is the same as that of the first embodiment. In the seventh embodiment, when the pass ends, the print sheet P is transported in the sub-scanning direction by four dots. In the fifth embodiment, a recording head having five nozzles will be described as an example in order to simplify the drawing.

### G1. Printing Method

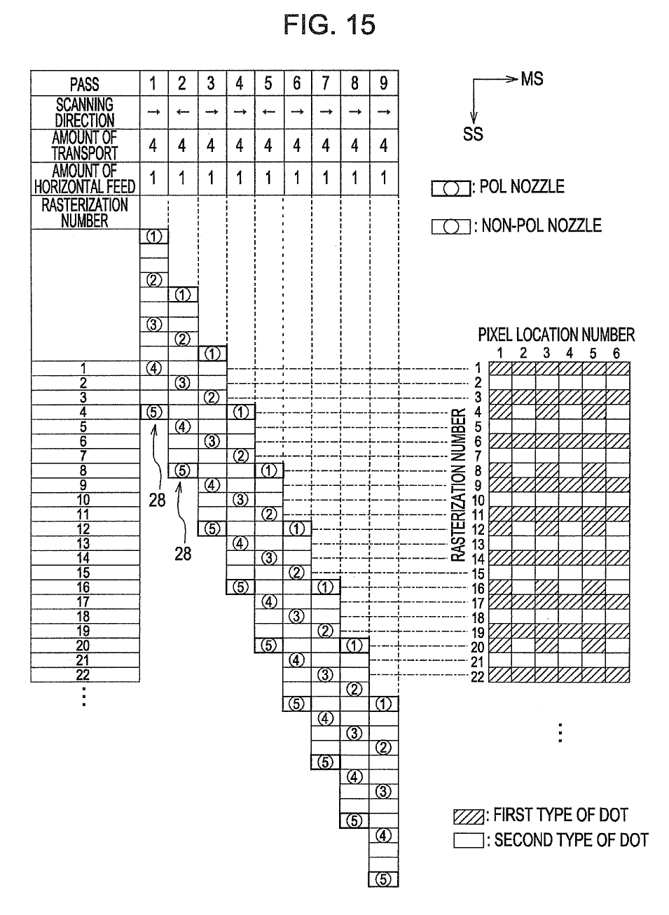

FIG. 15 is an explanatory diagram illustrating a printing method according to the seventh embodiment. In FIG. 15, the same reference numerals, signs, and hatching as those of FIG. 5 have the same meaning. In the seventh embodiment, as shown in FIG. 15, the nozzle pitch (=k) is three dots. In addition, as indicated by a full bold line outline, nozzle 1 provided in the upper end of each nozzle row of the recording head 28 is allocated as the upper end POL nozzle. In addition, nozzle 5 provided in the lower end of each nozzle row of the recording head 28 is allocated as the lower end POL nozzle.

As shown in FIG. 15, in a first pass, nozzle 5 forms the first type of dots at pixel locations 1, 3, and 5 of raster line 4 by allowing the recording head 28 to make the going movement. When the scanning process of the first pass ends, the print sheet P is transported in the sub-scanning direction by four dots. In a second pass, nozzle 5 forms the second type of dots at pixel locations 2, 4, and 6 of raster line 8 by allowing the recording head 28 to make the coming movement. Description of a third pass is omitted.

When the third pass ends and the print sheet P is transported in the sub-scanning direction by four dots, nozzle 1 is located in raster line 4 in a fourth pass. Since nozzle 1 is the POL nozzle, the nozzle forms the second type of dots at pixel locations 2, 4, and 6 of raster line 4. In consequence, the first type of dots and the second type of dots are alternately formed in raster line 4. When the fourth pass ends and the print sheet P is transported in the sub-scanning direction by four dots, nozzle 1 is located in raster line 8 in a fifth pass. Nozzle 1 forms the first type of dots at pixel locations 1, 3, and 5 of raster line 8. In consequence, the first type of dots and the second type of dots are alternately formed in raster line 8.

As described above, the amount of transport is uniform four dots and the POL nozzles are not changed. Therefore, the combination of nozzles 5 and 1 forming the POL raster is not changed and the POL raster is formed by the combination of nozzles 5 and 1 at an interval of four raster lines after raster line 4. In addition, in each pass, nozzles 2 to 4 form all the dots of one raster line in one-time scanning process.

In the printer according to the above-described seventh embodiment, in the bi-direction printing process to which the partial overlap method is applied, the normal feeding process of the print sheet P is performed so that the two kinds of dots formed in the different filling directions, that is, the dots formed by printing the liquid in the direction of the going movement and the dots formed by printing the liquid in the direction of the coming movement are contained in one POL raster. Accordingly, since the noise occurring in the main scanning direction can be prevented, it is possible to improve the quality of an image formed on the recording medium.

### H. Modified Examples

(1) In the above-described first to third embodiments, the number of upper end and lower end POL nozzles alternated in the odd-numbered pass and the even-numbered pass is not limited to the above-described numbers according to the respective embodiments. In addition, the invention is also not limited to the configuration in which the number of nozzles is alternated by the above-described amount of transport in the anomalous feeding process in the respective embodiments. The number of POL nozzles, the locations of the POL nozzles, the combination, and the amount of transport in the anomalous feeding process are appropriately determined in accordance with various conditions such as the number of nozzles, the nozzle pitch, the dot pitch, and the ratio of the POL rasters to all the raster lines. In this way, the printer realizing the various aspects can be configured such that the two types of dots formed in the different filling directions are contained in one POL raster. Accordingly, it is possible to improve the quality of an image formed on the recording medium.

(2) In the above-described embodiments, the POL nozzles form the first, third, and fifth pixels in the odd-numbered pass and form the second, fourth, and sixth pixels in the even-numbered pass, but this configuration may be arbitrarily determined. For example, an image printed on the print sheet P may be formed such that a first type of pixels and a second type of pixels are arranged in a zigzag lattice shape.

(3) The invention is applicable not only to a color printing process but also to a black-and-white printing process. The invention is applicable to a printing process of expressing multi gray scales by forming one pixel by a plurality of dots. The invention is applicable to a drum printer. In the drum printer, a drum rotation direction is the main scanning direction and a carriage movement direction is the sub-scanning direction. Moreover, the invention is applicable not only to an ink jet printer generally but also to a liquid ejecting apparatus capable of ejecting a liquid on the surface of a printing medium to perform a printing process by use of a recording head having a plurality of nozzle rows.

In the above-described embodiments, a part of the configuration realized by hardware may be replaced by software. Conversely, a part of the configuration realized by software may be replaced by hardware. For example, a part or the whole of the functions of the printer driver 96 shown in FIG. 1 may be realized by the control circuit 40 of the printer 20. In this case, a part or the whole of the functions of the computer 90 as a printing control device generating print data is realized by the control circuit 40 of the printer 20.

When a part or the whole of the functions according to the invention is realized by software, the software (a computer program) can be supplied in a form stored in a computer-readable recording medium. In the invention, “the computer-readable recording medium” is not limited to a portable recording medium such as a flexible disk or a CD-ROM, but includes an internal storage unit such as various RAMs or ROMs in a computer or an external storage unit such as a hard disk fixed to the computer.

The various embodiments of the invention have been described. However, the invention is not limited to these embodiments, but may be modified in various forms without departing the gist of the invention.

1. A liquid ejecting apparatus that forms an image on a recording medium, comprising:
a recording head that is provided with a nozzle row having a plurality of nozzles;
a head driving unit that moves the recording head in a main scanning direction;
a transport unit that transports the recording medium in a sub-scanning direction intersecting the main scanning direction; and
a dot control unit that ejects a liquid on the recording medium from the nozzles to form raster lines on the recording medium by controlling the head driving unit and the transport unit and that forms dots upon a going movement and dots upon a coming movement of the recording head in the main scanning direction and forms overlap raster lines of which one raster line contains the dots formed upon the going movement and the dots formed upon the coming movement.

2. The liquid ejecting apparatus according to claim 1, wherein the dot control unit forms the overlap raster lines so that pixels formed upon the going movement and pixels formed upon the coming movement are alternately arranged.

3. The liquid ejecting apparatus according to claim 1,
wherein the dot control unit forms the overlap raster lines by use of two nozzles arranged at different locations in the sub-scanning direction among the plurality of nozzles, and
wherein the dot control unit forms a first overlap raster line by use of a first nozzle and a second nozzle among the plurality of nozzles and forms a second overlap raster line by use of the first nozzle and a third nozzle different from the second nozzle, by transporting the recording medium by a first amount of transport in the sub-scanning direction upon ending the going movement of the recording head in the main scanning direction and by transporting the recording medium by a second amount of transport different from the first amount of transport upon ending the coming movement of the recording head in the main scanning direction.

4. The liquid ejecting apparatus according to claim 3, wherein the dot control unit intermittently forms the dots from n nozzles (where n is an integer equal to or larger than 1) provided in an upper end of the nozzle row and m nozzles (where m is an integer equal to or larger than 1) provided in a lower end of the nozzle row among the plurality of nozzles of the nozzle row upon the going movement of the recording head in the main scanning direction and intermittently forms the dots from m nozzles provided in the upper end and n nozzles provided in the lower end among the plurality of nozzles of the nozzle row upon the coming movement of the recording head in the main scanning direction, so as to form the first overlap raster line by use of the first and second nozzles and form the second overlap line by use of the first and third nozzles.

5. The liquid ejecting apparatus according to claim 3, wherein the dot control unit intermittently forms the dots from all the plurality of nozzles of the nozzle row.

6. The liquid ejecting apparatus according to claim 1, wherein the dot control unit forms the overlap raster lines by the dots ejected with non-continuous movement of the recording head in the main scanning direction.

7. A liquid ejecting method performed by a liquid ejecting apparatus that forms an image on a recording medium and includes a recording head that is provided with a nozzle row having a plurality of nozzles, a head driving unit that moves the recording head in a main scanning direction, a transport unit transporting the recording medium in a sub-scanning direction intersecting the main scanning direction, and a dot control unit that ejects a liquid on the recording medium from the nozzles to form raster lines on the recording medium while repeating the movement of the recording head in the main scanning direction and the transport of the recording medium in the sub-scanning direction by controlling the head driving unit and the transport unit, the liquid ejecting method comprising;
forming dots upon a going movement and dots upon a coming movement of the recording head in the main scanning direction; and
forming overlap raster lines of which one raster line contains the dots formed upon the going movement and the dots formed upon the coming movement.
